(19) United States
(12) Patent Application Publication
(10) Pub. No.: US 2011/0225799 A1
(43) Pub. Date: Sep. 22, 2011

(54) PRODUCTION APPARATUS AND PRODUCTION METHOD OF LIGHT EMITTING DEVICE

(75) Inventors: Satoru SHIMODA, Tokyo (JP); Isao Ebisawa, Tokyo (JP)

(73) Assignee: CASIO COMPUTER CO., LTD., Tokyo (JP)

(21) Appl. No.: 13/048,376

(22) Filed: Mar. 15, 2011

(30) Foreign Application Priority Data
Mar. 18, 2010 (JP) 2010-063157
Mar. 18, 2010 (JP) 2010-063158

(51) Int. Cl. B23P 19/00

(52) U.S. Cl. 29/460; 29/650

(57) ABSTRACT

The apparatus manufactures a light emitting device provided with a plurality of light emitting elements arranged on a substrate. The apparatus comprises: a rotating plate cylinder provided with a flexographic plate for printing ink that forms an organic layer of the light emitting elements on the substrate; an intermediate transfer member that contacts the flexographic plate to transfer the ink; a head unit that supplies the ink to the intermediate transfer member; a storage unit that stores as an ink replenishment pattern a region in which the ink is removed from the intermediate transfer member by the transfer of the ink from the intermediate transfer member to the flexographic plate; and a control unit that supplies the ink from the head unit to the region of the ink replenishment pattern on a surface of the intermediate transfer member.

### CROSS-REFERENCE TO RELATED APPLICATION

This application claims the benefit of Japanese Patent Application No. 2010-063157 filed Mar. 18, 2010 and Japanese Patent Application No. 2010-063158 filed Mar. 18, 2010, the entire disclosure of which is incorporated by reference herein.

### FIELD

This application relates generally to a manufacturing apparatus and a manufacturing method of a light emitting device.

### BACKGROUND

Self-light emitting devices refer to organic electroluminescence (EL) elements or organic light emitting diodes, and are formed by organic compounds that emit light when subjected to an electric field, or in other words, fluorescent organic compounds. Display devices provided with a display panel having such self-light emitting devices for each pixel thereof are attracting attention as next-generation display devices.

Organic EL elements are provided with an anode, a cathode and an organic EL layer (organic layer). The organic EL layer has, for example, a light emitting layer and a hole injection layer, is formed between the anode and the cathode, and emits light by energy generated by recombination of holes and electrons in the light emitting layer. Organic EL elements emit light by energy generated by recombination of holes and electrons in a light emitting layer.

Printing (to be referred to as flexographic printing) using a prescribed polymer material for the ink and a flexographic plate, which is a kind of relief printing plate, has conventionally been used to form such an organic layer on a substrate (see, for example, Unexamined Japanese Patent Application KOKAI Publication No. 2007-299616). A thin film such as a light emitting layer can be formed on a substrate by carrying out flexographic printing using a low viscosity ink. In addition, precise printing can be carried out with a flexographic printing apparatus by, for example, driving a plate cylinder in the form of a roller and an anilox roll with a direct drive motor and the like. For these reasons, flexographic printing can be preferably used for patterning the organic layer of an organic EL element.

### SUMMARY

In conventional flexographic printing methods, ink, which has been supplied from a dispenser (an ink chamber in Unexamined Japanese Patent Application KOKAI Publication No. 2007-299616) so as to spread over the entire surface of the anilox roll, is transferred to a flexographic plate in which a printing pattern is formed that is wrapped around the plate cylinder. Ink is printed onto a substrate serving as the target of printing by contacting the flexographic plate with the substrate.

Although surplus ink remaining on the anilox roll at that time is removed by a scraper (doctor), particles are generated as a result of contact between the anilox roll and the scraper, causing the ink to be contaminated by these foreign objects. Since the gap between the anode and cathode is extremely narrow in organic EL elements, there was the problem of even extremely small foreign objects causing the problem of the occurrence of defects such as dark spots due to short-circuiting between the electrodes.

With the foregoing in view, an object of the present invention is to provide a production apparatus and a production method of a light emitting device that effectively suppresses contamination by foreign objects during formation of fine structures in the manner of organic EL elements.

The manufacturing apparatus of a light emitting device of the present invention is an apparatus for manufacturing a light emitting device provided with a plurality of light emitting elements arranged on a substrate, and is provided with:

a rotating plate cylinder provided with a flexographic plate printing ink that forms an organic layer of the light emitting elements on the substrate;

an intermediate transfer member that contacts the flexographic plate to transfer the ink,

a head unit that supplies the ink to the intermediate transfer member;

a storage unit that stores as an ink replenishment pattern a region in which the ink is removed from the intermediate transfer member by the transfer of the ink from the intermediate transfer member to the flexographic plate; and

a control unit that supplies the ink from the head unit to the region of the ink replenishment pattern on a surface of the intermediate transfer member.

According to the present invention, contamination by foreign objects can be effectively prevented during formation of a fine structure in the manner of an organic EL element.

### BRIEF DESCRIPTION OF THE DRAWINGS

A more complete understanding of this application can be obtained when the following detailed description is considered in conjunction with the following drawings, in which:

FIG. 1 is a schematic diagram showing the configuration of a manufacturing device according to a first embodiment of the present invention;

FIG. 2 is a block diagram showing the main configuration of a manufacturing device;

FIG. 3 is a drawing showing a transfer operation of ink from an anilox roll to a plate cylinder;

FIG. 4 is a drawing showing a printing operation from a plate cylinder to a substrate;

FIG. 5 is an overhead view showing an example of the configuration of a light emitting device;

FIG. 6 is an equivalent circuit diagram of an example of a pixel drive circuit;

FIG. 7 is an overhead view of a pixel;

FIG. 8 is a cross-sectional view taken along line VI-VI shown in FIG. 7;

FIGS. 9A to 9C are drawings showing a production method of a light emitting device;

FIGS. 10A to 10C are drawings showing a production method of a light emitting device in continuation from FIGS. 9A to 9C;

FIG. 11 is a schematic diagram showing the configuration of a manufacturing device according to a second embodiment of the present invention;

FIG. 12 is a schematic diagram showing the configuration and operation of a manufacturing device according to a third embodiment of the present invention;

FIG. 13 is a drawing showing the operation of a manufacturing device in continuation from FIG. 12;

FIG. 14 is a schematic diagram showing the configuration of a manufacturing device according to a fourth embodiment of the present invention;

FIG. 15 is a schematic diagram showing the configuration of a manufacturing device according to a fifth embodiment of the present invention;

FIG. 16 is a schematic diagram showing the configuration of a manufacturing device according to a sixth embodiment of the present invention;

FIG. 17 is a block diagram showing the main configuration of a manufacturing device;

FIG. 18 is a drawing showing a transfer operation of ink from an anilox roll to a plate cylinder;

FIG. 19 is a drawing showing a printing operation from a plate cylinder to a substrate;

FIGS. 20A and 20B are drawings showing electronic equipment in which a light emitting device is used;

FIG. 21 is a drawing showing electronic equipment in which a light emitting device is used;

FIG. 22 is a drawing showing electronic equipment in which a light emitting device is used;

FIG. 23 is a drawing showing electronic equipment in which a light emitting device is used; and

FIGS. 24A and 24B are schematic diagrams showing an example of the configuration of a head.

### DETAILED DESCRIPTION

The following provides an explanation of embodiments of the present invention with reference to the appended drawings.

### First Embodiment

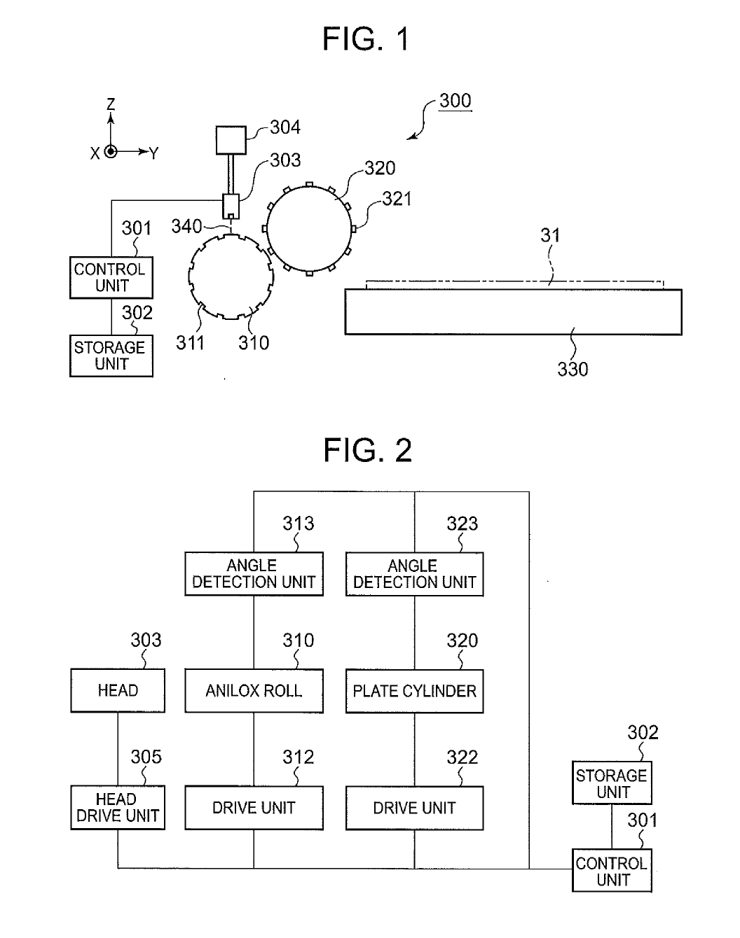

As shown in FIG. 1, a manufacturing device 300 according to a first embodiment is provided with a control unit 301, a storage unit 302, a head 303, an ink container 304 in which ink 340 is contained, an anilox roll 310, a plate cylinder 320 and a printing stage 330.

Furthermore, in the present specification, a Cartesian coordinate system composed of an X axis, Y axis and Z axis is used for the sake of convenience in the explanation. The X axis is a coordinate axis extending perpendicular to the surface of the paper in the drawings, and the direction from the back to the front of the paper is defined as the positive direction. The Y axis is a coordinate axis extending to the left and right in the drawings, and the direction from left to right is defined as the positive direction. In addition, the Z axis is a coordinate axis extending upward and downward in the drawings, and the direction from bottom to top is defined as the positive direction.

The control unit 301 is provided with a central processing unit (CPU) and the like, and controls all functions of the manufacturing device 300, including discharge of ink from the head 303 to be subsequently described and driving of the anilox roll 310 and the plate cylinder 320.

The storage unit 302 is a storage device comprising read only memory (ROM), random access memory (RAM) and the like. A program executed by the control unit 301 and data relating to printing patterns generated by a plate on the plate cylinder 320, for example, are housed in the storage unit 302. In addition, the storage unit 302 also functions as, for example, a workspace memory when the control unit 301 executes a program.

The head 303 discharges the ink 340 towards the anilox roll 310 based on instructions from the control unit 301. In the present embodiment, the head 303 is provided with a piezoelectric element (not shown), and discharges the ink 340 using a so-called inkjet method.

In addition, the head 303 is configured to be able to discharge the ink 340 while scanning in the direction of the X axis in the drawings according to the length of the anilox roll 310. The ink container 304 contains the ink 340 therein, and supplies the ink 340 to the head 303. The ink 340 in the present embodiment is, for example, a solution of a so-called polymer material that serves as a material of the light emitting layer of an organic EL element.

The anilox roll 310 is rotatably supported about a rotating shaft (not shown) parallel to the X axis in the drawings, and has a prescribed length in the direction of the X axis. A large number of shallow recesses, namely cells 311, are formed in the outer peripheral surface, namely the surface that receives the ink 340, of the anilox roll 310. Although the cells 311 are depicted in a simplified form in FIG. 1, the cells 311 are provided so as to have a prescribed depth, pattern and the like corresponding to printing conditions. Furthermore, if the head 303 extends in the direction of the X axis corresponding to the length in the direction of the X axis of the anilox roll 310, and a plurality of discharge ports that arbitrarily discharge the ink 340 are arranged along the X axis, the ink 340 can be discharged into the arbitrary cells 311 of the anilox roll 310 without having the head 303 scan in the direction of the X axis.

The plate cylinder 320 is rotatably supported about a rotating shaft (not shown) parallel to the X axis in the drawings, and has a prescribed length in the direction of the X axis.

As will be subsequently described, in addition to rotating about the rotating shaft as previously described, the plate cylinder 320 is configured to also be able to move parallel to a printed surface of a substrate 31 (move in the direction of the Y axis in the drawings) placed on the printing stage 330, and move in a direction perpendicular to the printed surface of the substrate 31 (namely, a direction normal to the printed surface, or in other words, in the direction of the Z axis in the drawings). One or a plurality of protrusions 321 of a flexographic plate are formed on the outer peripheral surface of the plate cylinder 320. The plate protrusions 321 are formed to have a prescribed pattern corresponding to a printed light emitting layer and the like, receive the ink 340 from the anilox roll 310, and transfer that ink 340 to the substrate 31 targeted for printing. A portion of the flexographic plate on the plate cylinder 320 (that includes the protrusions 321) is formed from a material suitable for flexographic printing such as plastic or rubber. Furthermore, the substrate 31 is fixed on the printing stage 330 in the present embodiment.

The printing stage 330 is a stage for placing the substrate 31 targeted for printing by the manufacturing device 300 parallel to the XY plane in the drawings. Furthermore, a detailed explanation of the configuration of the printing stage 330, such as the mechanism used to fix the substrate 31, is omitted in the present specification.

FIG. 2 is a block diagram showing a detailed configuration relating to the control unit 301 of the manufacturing device 300. As shown in FIG. 2, in addition to having the configuration shown in FIG. 1, the manufacturing device 300 is provided with a head drive unit 305, a drive unit 312, an angle detection unit 313, a drive unit 322 and an angle detection unit 323.

The head drive unit 305 discharges the ink 340 by driving a piezoelectric element incorporated within the head 303 based on instructions from the control unit 301. In addition, the head drive unit 305 is provided with a mechanism such as a drive motor (not shown) and rail, and causes the head 303 to scan in the direction of the X axis.

The drive unit 312 is provided with a direct drive type of drive motor (not shown), and causes the ink 340 discharged from the head 303 to reach a prescribed position on the anilox roll 310 by rotating the anilox roll 310 based on instructions from the control unit 301.

The angle detection unit 313 is an angle sensor provided on the rotating shaft of the anilox roll 310 or a drive motor. The angle detection unit 313 detects the position of the anilox roll 310 by detecting an angle of rotation of the anilox roll 310 either directly or indirectly, and transmits a signal indicating that position to the control unit 301.

The drive unit 322 is provided with a direct drive type of drive motor (not shown), and causes, by rotating the plate cylinder 320, the ink 340 discharged onto the anilox roll 310 to be transferred to a prescribed position on the plate cylinder 320, or causes the plate cylinder 320 to move in the direction of the Y axis and Z axis in the drawings as will be subsequently described, based on instructions from the control unit 301.

The angle detection unit 323 is an angle sensor provided on the rotating shaft of the plate cylinder 320 or a drive motor. The angle detection unit 323 detects the position of the plate cylinder 320 either directly or indirectly, and transmits a signal indicating that position to the control unit 301.

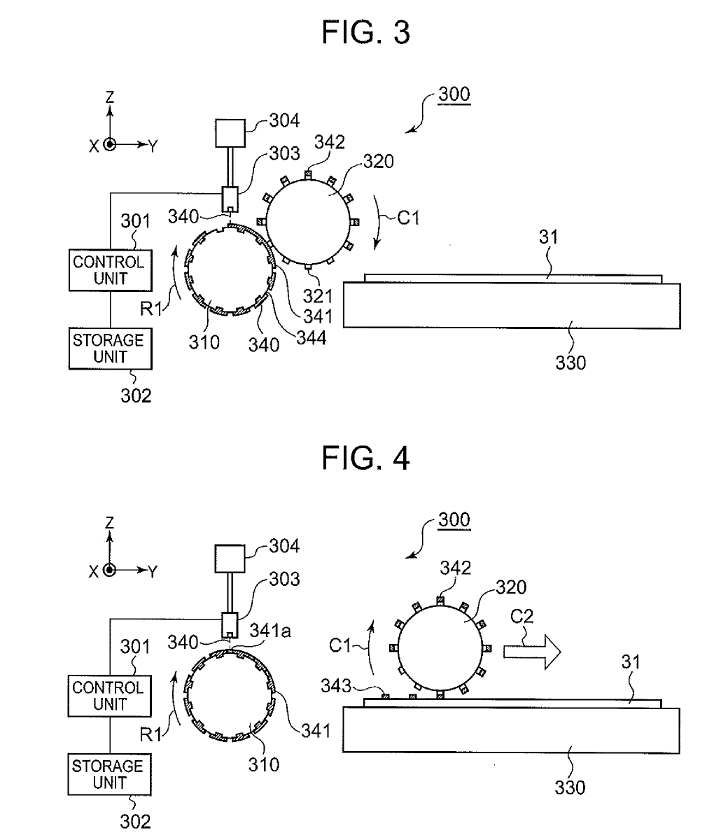

Next, an explanation is provided of operation of the manufacturing device 300 with reference to FIGS. 3 and 4. Furthermore, unless specifically indicated otherwise, operation of the manufacturing device 300 as described below is carried out based on instructions from the control unit 301. In addition, in the following explanation, a surface of the anilox roll 310 refers to the outer peripheral surface of the anilox roll 310 that includes the range of the cells 311.

As shown in FIG. 3, the head 303 first discharges the ink 340 towards the anilox roll 310. If the transferring ink from the anilox roll 310 to the plate cylinder 320 is put aside from the consideration, a uniform ink film 341 is formed over the entire circumference of the surface of the anilox roll 310 in this step. In addition, the head 303 covers the range of the length of the anilox roll 310 by scanning in the direction of the X axis in the drawing. In other words, the head 303 is able to discharge the ink 340 over the entire range of length of the anilox roll 310.

In coordination with the step for forming the ink film 341 as described above, the anilox roll 310 serving as an intermediate transfer member transfers ink to the plate cylinder 320. At this time, the anilox roll 310 rotates in the direction of arrow R1, while the plate cylinder 320 rotates in the direction of arrow C1. The control unit 301 detects the position of the anilox roll 310 with the angle detection unit 313, and detects the position of the plate cylinder 320 with the angle detection unit 323. The control unit 301 then rotates the anilox roll 310 by controlling the drive unit 312 and rotates the plate cylinder 320 by controlling the drive unit 322 so that ink is accurately transferred. Furthermore, one or both of the anilox roll 310 and the plate cylinder 320 may also be rotated in the opposite direction of that shown in the drawing (and to apply similarly to other embodiments subsequently described).

In addition, the head 303 continues to discharge the ink 340 until it the head 303 completes one revolution about the anilox roll 310. Furthermore, although discharge of the ink 340 from the head 303 to the anilox roll 310 and the transfer operation from the anilox roll 310 to the plate cylinder 320 are carried out concurrently in the example of FIG. 3, transfer of the ink 340 to the plate cylinder 320 may also be carried out after discharge of the ink 340, namely after formation of the ink film 341 has been completed.

An ink film 342 is formed on the surface of the plate on the plate cylinder 320 to which ink has been transferred in the manner of the example of FIG. 3. The ink constituting the ink film 341 is moved to the corresponding surface of the anilox roll 310 and, therefore, has been removed from the cylinder 320.

When transfer of ink to the plate on the plate cylinder 320, namely formation of the ink film 342, is completed, the plate cylinder 320 moves to a prescribed position over the substrate 31 as shown in FIG. 4 and begins to print the substrate 31 from that position. At this time, since the plate cylinder 320 rotates in the direction of arrow C1 while the plate provided on the plate cylinder 320 contacts the substrate 31, the plate cylinder 320 moves in the direction of arrow C2. An ink film 343, which serves as an organic layer of an organic EL element, for example, is then formed on the surface of the substrate 31.

As has been described above, the ink film 341 on the surface of the anilox roll 310 is transferred to the surface of the plate on the plate cylinder 320. The head 303 discharges the ink 340 to locations on the surface of the anilox roll 310 where the ink 340 has been removed, namely ink replenished locations 344, and the ink film 341 is uniformly reformed over the entire circumference of the surface of the anilox roll 310. A pattern in which the ink 340 is discharged in this step (ink replenishment pattern) is stored in advance, namely before the ink 340 is removed from the surface of the anilox roll 310, is stored in the storage unit 302. The control unit 301 controls the drive unit 312 so that the ink replenished portions 344 of the anilox roll 310 accurately oppose the head 303 based on the position of the anilox roll 310 obtained from the angle detection unit 313 and the ink replenishment pattern. The replenished ink film 341a formed at the ink replenished locations 344 by discharge of the ink 340 from the head 303 is integrated with the remaining ink film 341 to form the uniform ink film 341 over the entire circumference of the anilox roll 310. Subsequently, ink transfer to the plate on the plate cylinder 320 and printing onto the substrate 31 can be repeated as shown in FIG. 3.

Next, an explanation is provided of a light emitting device 10 manufactured using the manufacturing device 300. Furthermore, the following explanation uses as an example a light emitting device of the active drive type that uses a bottom emission type of organic EL element in which light emitted by the organic EL element is emitted to the outside through a substrate on which the organic EL element is formed. In addition, the light emitting device described in the present specification is also used as a display device.

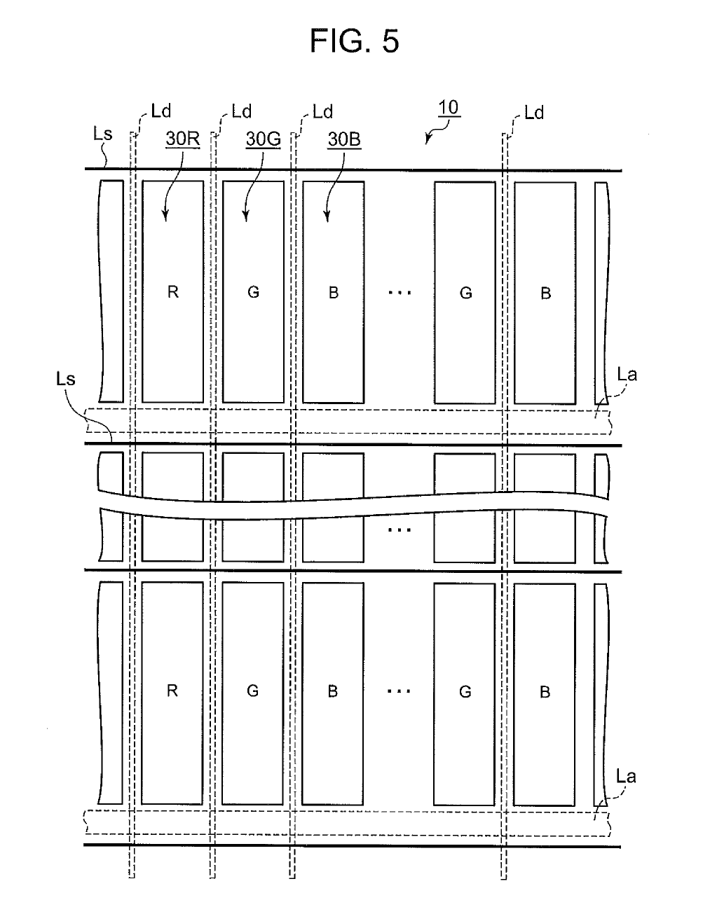

As shown in FIG. 5, the light emitting device 10 is formed on the previously described substrate 31. In the case the light emitting device 10 carries out color display, three pixels 30 (30R, 30G, 30B), having light emitting elements that respectively emit lighting colors of any of three colors consisting of red (R), green (G) and blue (B), are arranged in groups such that a plurality of these groups, for example, m groups, are repeatedly arranged in a row direction (to the left and right in FIG. 5), while a plurality of pixels, for example, n pixels, having light emitting elements of the same lighting color are arranged in a column direction (upward and downward in FIG. 5). In other words, a number of pixels equal to 3m pixels are arranged in the row direction, while a number of pixels equal to n pixels are arranged in the column direction on the substrate 31. Namely, pixels emitting each color of R, G and B are arranged in the form of a 3m×n matrix on the substrate 31.

The following provides an explanation of the light emitting device 10, using the pixels 30G as an example of pixels comprising the light emitting device 10. Furthermore, in the present embodiment, the configurations of the pixels 30R, 30G and 30B are the same with the exception of being provided with light emitting layers 45R, 45G and 45B, respectively. Thus, explanations of the configurations of the pixels 30R and 30B are omitted.

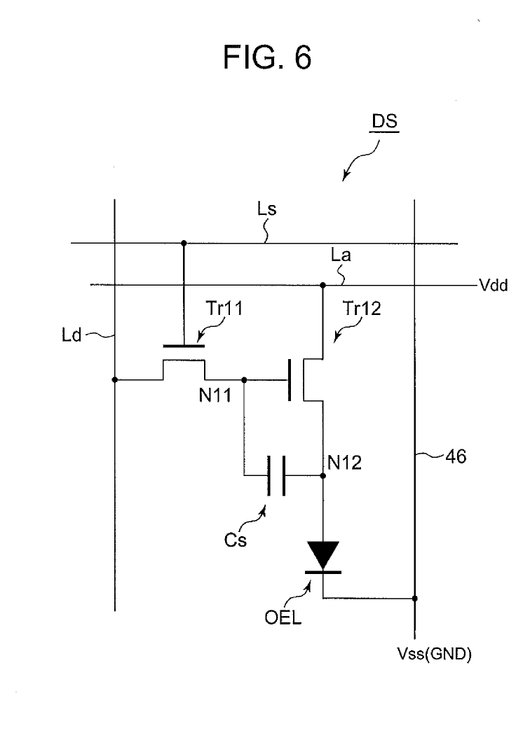

The pixels 30G comprises a pixel circuit DS. As shown in FIG. 6, for example, the pixel circuit DS is provided with a selection transistor Tr11, a drive transistor Tr12, a capacitor Cs and an organic EL element (light emitting element) OEL.

The selection transistor Tr11 has a gate terminal connected to a scanning line Ls, a drain terminal connected to a data line Ld, and a source terminal connected to a contact point N11. In addition, the drive transistor Tr12 has a gate terminal connected to the contact point N11, a drain terminal connected to an anode line La, and a source terminal connected to a contact point N12. The capacitor Cs is connected to a gate terminal and a source terminal of the drive transistor Tr12. Furthermore, the capacitor Cs is an auxiliary capacitance additionally provided between the gate and source of the drive transistor Tr12, or a capacitance component including a parasitic capacitance and an auxiliary capacitance between the gate and source of the drive transistor Tr12. In addition, in the organic EL element OEL, an anode (pixel electrode 42) is connected to the contact point N12, and a reference voltage Vss is applied to a cathode (counter electrode 46).

The scanning line Ls is connected to a scanning driver (not shown) arranged on an edge portion of a pixel substrate, and a selected voltage signal (scanning signal) for setting a selection status of a plurality of the pixels 30 arranged in the row direction is applied thereto at a prescribed timing. In addition, the data line Ld is connected to a data driver (not shown) arranged on an edge portion of the pixel substrate, and a data voltage (a gradation signal) corresponding to light emission data is applied thereto at timing synchronous to the selection status of the pixels 30. The anode line La (supply voltage line) is directly or indirectly connected to a prescribed high-potential voltage so as to set a plurality of the drive transistors Tr12 arranged in the row direction to a state in which a drive current corresponding to the light emission data is applied to the pixel electrode 42 (anode, for example) of the organic EL element OEL connected to the drive transistor Tr12. In other words, the anode line La applies a prescribed high potential (a supply voltage Vdd) that is sufficiently higher than the reference voltage Vss applied to the counter electrode 46 of the organic EL element OEL. In addition, the counter electrode 46 is directly or indirectly connected to a prescribed low potential power supply, is formed from a single electrode layer for all of the pixels 30 arranged in the form of an array on the substrate 31, and is set so that a prescribed low voltage (reference voltage Vss, such as a ground potential GND) is commonly applied thereto.

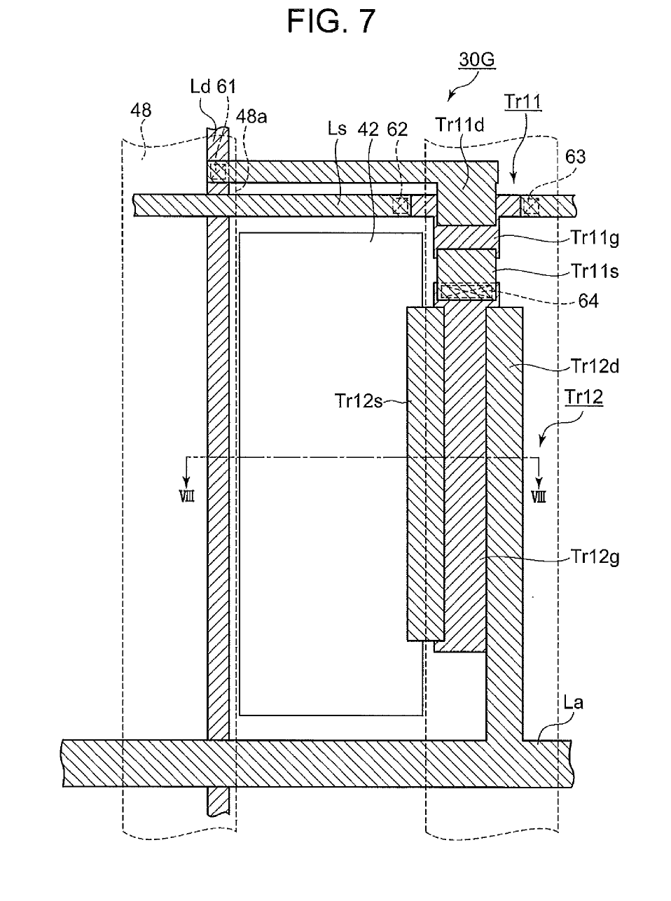

In addition, the anode line La and the scanning line Ls are formed on both source electrode and drain electrode of each transistor Tr11 and Tr12 using source-drain conductive layers that form these source and drain electrodes. The data line Ld is formed on the gate electrode using a gate conductive layer serving as gate electrodes of each transistor Tr11 and Tr12. A contact hole 61 is formed in an insulating film 32 between the data line Ld and a drain electrode Tr11d as shown in FIG. 7, and the data line Ld and the drain electrode Tr11d are in electrical continuity through the contact hole 61. Contact holes 62 and 63 are respectively formed in the insulating film 32 between the scanning line Ls and both ends of a gate electrode Tr11g, and the scanning line Ls and the gate electrode Tr11g are in electrical continuity through the contact holes 62 and 63. A contact hole 64 is formed in the insulating film 32 between a source electrode Tr11s and a gate electrode Tr12g, and the source electrode Tr11s and the gate electrode Tr12g are in electrical continuity through the contact hole 64. Furthermore, the insulating film 32 is formed from an insulating material such as a silicon oxide film or silicon nitride film, and is formed on the substrate 31 so as to cover the data line Ld, the gate electrode Tr11g and the gate electrode Tr12g.

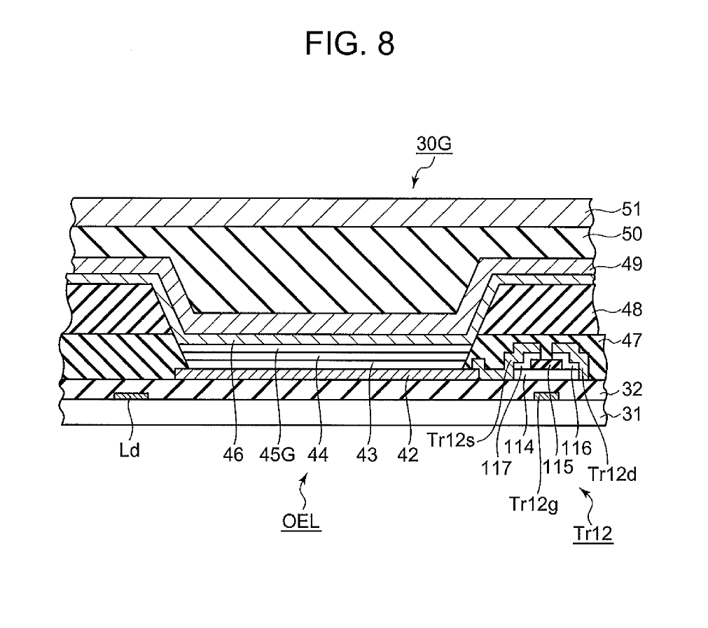

As shown in FIG. 8, the organic EL element OEL is provided with the pixel electrode 42, a hole injection layer 43, an interlayer 44, the light emitting layer 45G and the counter electrode 46. Furthermore, although an example of a configuration in which the hole injection layer 43 and the light emitting layer 45G are provided as light emitting function layers that contribute to light emission is shown in FIG. 8, the light emitting function layer may be composed only of the light emitting layer 45G or may comprise the hole injection layer 43 and the light emitting layer 45G.

The gate electrodes Tr11g and Tr12g of the selection transistors Tr11 and drive transistors Tr12 obtained by patterning gate conductive layers are formed on the substrate 31 of each pixel. A data line Ld that extends in the column direction is formed by pattering a gate conductive layer on the substrate 31 adjacent to each pixel.

The pixel electrode (anode) 42 includes electrically conductive transparent material such as indium tin oxide (ITO) or ZnO. Each pixel electrode 42 is insulated from the pixel electrode 42 of another pixel 30 adjacent thereto by an interlayer insulating film 47.

The interlayer insulating film 47 is formed from an insulating material such as a silicon nitride film. The interlayer insulating film 47 is formed between the pixel electrodes 42, and insulates and protects the transistors Tr11 and Tr12, the scanning line Ls and the anode line La. A roughly square opening 47a is formed in the interlayer insulating film 47, and light emitting regions of the pixels 30G are demarcated by this opening 47a. Moreover, a partition 48 is formed on the interlayer insulating film 47. A groove-like opening 48a extending in the column direction (upward and downward directions of FIG. 7) is formed in the partition 48 along the plurality of pixels 30. Here, the interlayer insulating film 47 and the partition 48 formed thereon form a gap region between adjacent light emitting regions of each pixel 30 arranged in the row direction.

The partition 48 is formed on the interlayer insulating film 47 by curing an insulating material such as a photosensitive resin in the manner of polyimide. The partition 48 is formed in the form of a stripe such that the pixel electrodes 42 of a plurality of pixels collectively open along the column direction as shown in FIG. 7. Furthermore, the planar shape of the partition 48 is not limited thereto, but rather may also be in the form of a lattice having an opening for each pixel electrode 42. In addition, the upper surface of the partition 48 is formed to be higher than the upper surface of a flat portion in the center of the light emitting layers 45R, 45G and 45B.

Furthermore, the surface of the partition 48 and the surface of the interlayer insulating film 47 may be subjected to liquid repellency treatment. Here, liquid repellency refers to the property of repelling both aqueous solvents and organic solvents.

The hole injection layer 43 is formed on the pixel electrode 42. The hole injection layer 43 has a function of supplying holes to the light emitting layer 45. The hole injection layer 43 includes an organic polymer-based material capable of injecting and transporting holes, such as PEDOT:PSS (a mixture of an electrically conductive polymer in the form of polyethylene dioxythiophene and a dopant in the form of polystyrene sulfonate).

The interlayer 44 is formed on the hole injection layer 43. The interlayer 44 has a function of facilitating recombination of electrons and holes within the light emitting layer 45G by blocking electrons, and enhances luminous efficiency of the light emitting layer 45G.

The light emitting layer 45G is formed on the hole injection layer 43. The light emitting layer 45G (as well as 45R and 45B) has a function of generating light of a lighting color of each pixel by applying a voltage between the anode 42 and the cathode 46. The light emitting layer 45G includes a known polymer light-emitting material capable of emitting fluorescent or phosphorescent light such as a light-emitting material containing a conjugated double bond polymer in the manner of a poly(para-phenylene vinylene)-based or polyfluorene-based polymer. In addition, these light-emitting materials can be formed by coating a solution (dispersion) obtained by dissolving (or dispersing) in a suitable aqueous solvent or organic solvent such as tetralin, tetramethylbenzene, mesitylene or xylene followed by evaporating the solvent.

The counter electrode (cathode) 46 is provided on the side of the light emitting layer 45G in the case the organic EL element OEL is of the bottom emission type, and has a laminated structure having an electron-injecting lower layer including a material having a low work function such as Li, Mg, Ca or Ba, and an upper layer including a light-reflecting electrically conductive metal such as Al. In the present embodiment, the counter electrode 46 includes a single electrode layer formed across a plurality of the pixels 30, and a ground potential that is the reference voltage Vss is applied thereto. Furthermore, in the case the organic EL element OEL is of the top emission type, the counter electrode 46 is provided on the side of the light emitting layer 45G, and has a transparent laminated structure having an extremely thin low work function layer having a film thickness of about 10 nm and including a material having a low work function such as Li, Mg, Ca or Ba, and a light-transmitting electrically conductive layer such as ITO having a film thickness of about 100 nm to 200 nm.

A passivation film 49 is provided on the counter electrode 46. An adhesive layer 50 is provided on the passivation layer 49. A sealing substrate 51 is provided on the adhesive layer 50.

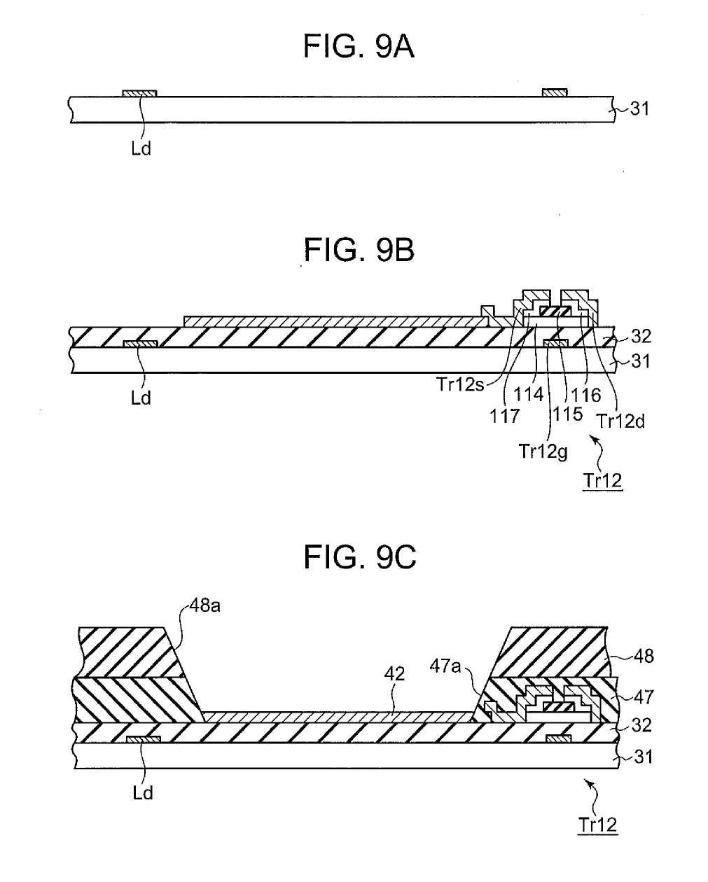

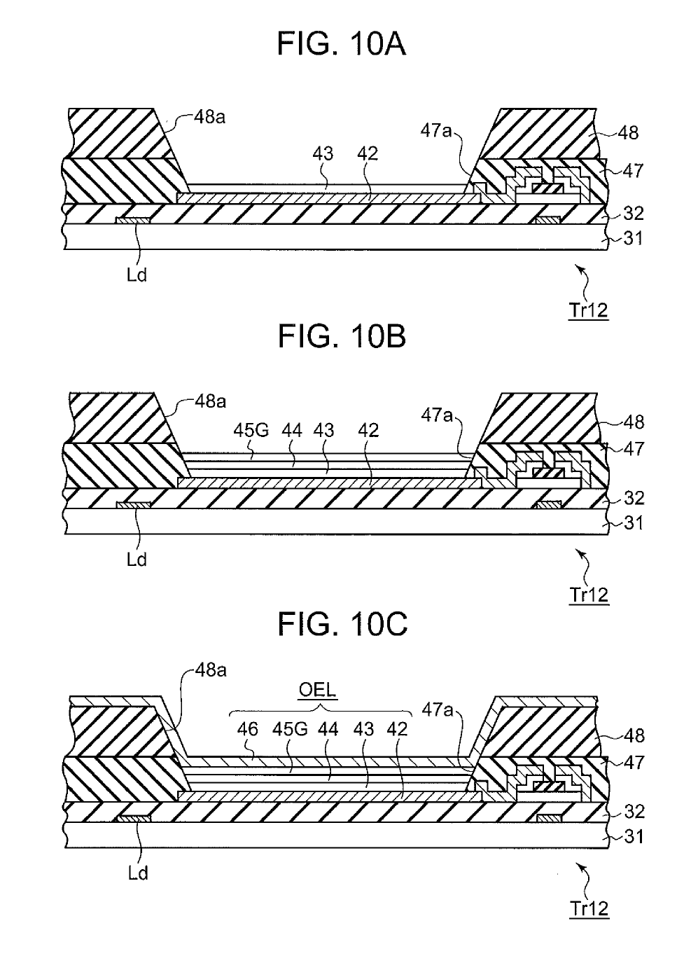

Next, an explanation is provided of a method of manufacturing the light emitting device 10 using FIGS. 9A to 9C and FIGS. 10A to 10C. Furthermore, since the selection transistor Tr11 is formed by the same process as the drive transistor Tr12, an explanation of formation of the selection transistor Tr11 is partially omitted.

As shown in FIG. 9A, the substrate 31 including a glass substrate and the like is first procured. Next, a gate electrically conductive film, including an Mo film, Cr film, Al film, Cr/Al laminated film, AlTi alloy film or AlNdTi alloy film, AlNi alloy film or MoNb alloy film and the like, is formed on the substrate 31 by sputtering or vacuum deposition and the like, and this is patterned in the shape of the gate electrode Tr12g of the drive transistor Tr12 as shown in FIG. 9A. Although not shown in the drawings, the gate electrode Tr11g of the selection transistor Tr11 and the data line Ld are also formed at this time. Continuing, the insulating film 32 is formed on the gate electrode Tr12g and the data line Ld by chemical vapor deposition (CVD) and the like as shown in FIG. 9B.

Next, a semiconductor layer including at least one of amorphous silicon, micro crystal silicon and poly-silicon is formed on the insulating film 32 by CVD and the like. Next, an insulating film including SiN, for example, is formed on the semiconductor layer by CVD and the like. Continuing, the insulating film is patterned by photolithography and the like to form a stopper film 115. Moreover, a film including at least one of amorphous silicon, micro crystal silicon and poly-silicon containing n-type impurities is formed on the semiconductor layer and the stopper 115 film by CVD and the like, and a semiconductor layer 114 and ohmic contact layers 116 and 117 are formed as shown in FIG. 9B by patterning this film and the semiconductor layer by photolithography and the like.

Next, a transparent electrically conductive film such as ITO or a light-reflecting electrically conductive film and transparent electrically film such as ITO are coated onto the insulating film 32 by sputtering or vacuum deposition and the like, followed by patterning by photolithography to form the pixel electrode 42.

Continuing, after forming through holes in the form of the contact holes 61 to 64 in the insulating film 32, a source-drain electrically conductive film including, for example, an Mo film, Cr film, Al film, Cr/Al laminated film, AlTi alloy film or AlNdTi alloy film, AlNi alloy film of MoNb alloy film, is coated by sputtering or vacuum deposition and the like, followed by patterning by photolithography to form a drain electrode Tr12d and a source electrode Tr12s as shown in FIG. 9B. The anode line La is formed simultaneous thereto. At this time, the source electrode Tr12s of the drive transistor Tr12 is formed so as to partially overlap each pixel electrode 42.

Continuing, after having formed the interlayer insulating film 47 including a silicon nitride film by CVD and the like so as to cover the drive transistor Tr12 and the like, the opening 47a is formed by photolithography as shown in FIG. 9C. Next, a photosensitive polyimide is coated so as to cover the interlayer insulating film 47, and then patterned by exposing and developing through a mask corresponding to the shape of the partition 48 to form the partition 48 having the opening 48a as shown in FIG. 9C.

Next, the light emitting layer 45G is formed as shown in FIG. 10A. Here, a PEDOT:PSS solution serving as the hole injection layer is selectively printed as the ink 340 on the pixel electrode 42 surrounded by the opening 47a with the previously described manufacturing device 300. The ink 340 is prepared as a PEDOT:PSS ink by adding an alcohol, nonionic surfactant or ethylene glycol and the like to PEDOT:PSS to adjust viscosity and surface tension. Continuing, the substrate 31 is dried for 5 to 30 minutes at 150° C. to 250° C. in an air atmosphere. As a result, a solvent of an organic compound-containing solution is evaporated, and the hole injection layer 43 is formed. The organic compound-containing solution may also be coated in a heated atmosphere. Furthermore, the pattern of the protrusions 321 of the plate on a flexographic plate in the form of the plate cylinder 320 may be preliminarily formed in a prescribed pattern using photolithography corresponding to the pattern of each printed layer. In addition, in the manufacturing device 300 for the injection hole layer, since the thickness of the protrusions 321 of the plate on the plate cylinder 320 are sufficiently larger than the total thickness of the interlayer insulating film 47 and the partition 48, the plate on the plate cylinder 320 allows the ink 340 of the ink film 342 to easily protrude onto the pixel electrode 42.

Next, the interlayer 44 is formed as shown in FIG. 10B. Here, an organic compound-containing solution containing a material serving as the interlayer 44 is printed as the ink 340 onto the hole injection layer 43 surrounded by the opening 47a with the manufacturing device 300. Continuing, the interlayer 44 is formed by removing residua solvent by heating and drying in an inert atmosphere such as nitrogen or argon or by heating and drying in a vacuum. The organic compound-containing solution may also be coated in a heated atmosphere. Furthermore, the hole injection layer 43 and the interlayer 44 can be formed from a common material even in the case of providing a plurality of colors of light emitting layers 45 as in the present embodiment. In addition, in the manufacturing device 300 used to print the interlayer 44, since the thickness of the protrusions 321 of the plate on the plate cylinder 320 are sufficiently higher than the sum of the thickness of the interlayer insulating film 47 and the thickness of the partition 48, the plate on the plate cylinder 320 allows the ink 340 of the ink film 342 to easily protrude onto the hole injection layer 43.

Next, the light emitting layer 45G is formed. Here, an organic compound-containing solution containing a light-emitting polymer material (R, G or B) is printed onto the interlayer 44 surrounded by the opening 47a as the ink 340 with the manufacturing device 300. The ink 340 is prepared to a prescribed concentration by dissolving a polyolefin-based polymer light-emitting material in a solvent such as toluene, xylene, mesitylene or tetramethylbenzene. The solvent may also be mixture of the above-mentioned solvents. Continuing, the solvent in the film is removed by heating for 10 to 30 minutes in a dry atmosphere or vacuum having a dew point of −70° C. or lower at a temperature of 80 to 150° C. provided the temperature is equal to or lower than the glass transition temperature of the light emitting layer. In addition, in the manufacturing device 300 used for the light emitting layer, since the thickness of the protrusions 321 of the plate of the plate cylinder 320 is sufficiently larger than the total thickness of the interlayer insulating film 47 and the partition 48, the plate of the plate cylinder 320 allows the ink 340 of the ink film 342 to easily protrude onto the interlayer 44.

Next, the counter electrode 46 is formed as shown in FIG. 10C. Here, after cooling while maintaining a dry atmosphere, an alkaline metal, alkaline earth metal or compound thereof, such as Li, Mg, LiF, Ca or Ba, is formed by a deposition method such as vacuum deposition or electron beam deposition on the substrate 31 formed to the light emitting layer 45G. Continuing, a light-reflecting electrically conductive layer such as Al is formed by vapor deposition or electron beam deposition. As a result, the counter layer 46 is formed having a bilayer structure.

Next, the passivation layer 49 is formed by layering SiN or SiON and the like on the counter electrode 46 by electron beam deposition, sputtering or CVD as shown in FIG. 8. Continuing, the adhesive layer 50, including a UV-curable resin or thermosetting resin, is coated onto the passivation layer 49, and the sealing substrate 51, formed from a glass or metal cap, is laminated onto the coated surface. Continuing, the adhesive layer 50 is cured by ultraviolet rays or heat to join the substrate 31 and the sealing substrate 51. The light emitting device 10 is thereby manufactured.

As has been previously explained, in the present embodiment, the homogeneous ink 340 is formed by using an inkjet method to discharge the ink 340 only over a portion of the ink film 341 on the anilox roll 310 where the ink has been removed by transferring to the plate on the plate cylinder 320 in flexographic printing. As a result, since it is not necessary to remove ink by sliding a scraper over the surface of an anilox roll as in the case of conventional flexographic printing, contamination by foreign objects can be suppressed. In the case of applying the present invention to an organic layer formed in a fine structure in which a gap between an anode and a cathode is roughly several hundred nm as in an organic EL element in particular, the possibility of the occurrence of dark spots and other defects caused by short-circuiting between the electrodes can be reduced, thereby making this particularly preferable.

### Second Embodiment

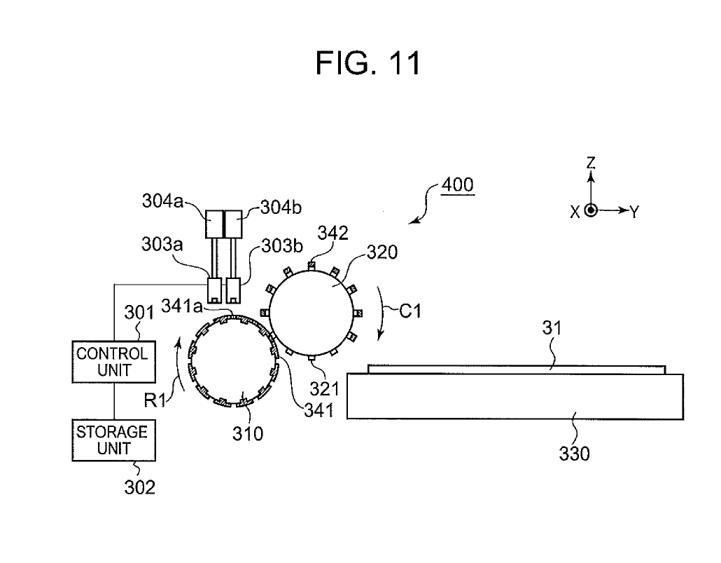

As shown in FIG. 11, a manufacturing device 400 according to a second embodiment is provided with two heads consisting of a head 303a and a head 303b, thereby differing from the manufacturing device 300 of the first embodiment that is provided with a single head 303. Furthermore, in the following explanation, the same reference symbols are used to indicate those constituents that are the same as those of the previously described embodiment, and detailed explanations thereof are omitted.

An ink container 304a is connected to the head 303a. The ink 340 of the same prescribed concentration of the first embodiment is contained in the ink container 304a. The head 303a is arranged so as to be able to discharge the ink 340 towards the anilox roll 310 in the same manner as the first embodiment.

An ink container 304b is connected to the head 303b. An ink of a lower concentration than the ink 340 is contained in the ink container 304b. The head 303b is arranged so as to be able to discharge ink towards the anilox roll 310 while scanning the lengthwise direction (direction of the X axis in the drawing) of the substrate 31 in the same manner as the head 303a.

Next, an explanation is provided of operation of the manufacturing device 400. As shown in FIG. 11, replenishment of ink as explained in FIG. 4 is carried out by the two heads 303a and 303b in the present embodiment.

First, a prescribed concentration of ink is discharged from the head 303a to the ink replenished locations 344 on the surface of the anilox roll 310 to form the replenished ink film 341a. Continuing, an ink of a concentration lower than a prescribed concentration is discharged from the head 303b. Ink discharged from the head 303b is either discharged to a portion where ink has not been transferred or uniformly discharged over the entire anilox roll 310 to compensate for solvent that has evaporated during rotation of the anilox roll 310. As a result of the replenished ink film 341a contacting the remaining ink film 341 in this manner, ink having a relatively lower concentration and the ink 340 having a relatively higher concentration mix so that the mixed ink concentration is uniform within the ink film 341. Operation of the heads 303a and 303b is carried out under control by the control unit 301 based on the position of the anilox roll 310 detected by the angle detection unit 313 in the same manner as the head 303 of the first embodiment.

In this manner, the ink film 341 having higher uniformity of concentration and film thickness over the entire circumference thereof can be formed by coating inks having a plurality of concentrations. Thus, according to the present embodiment, uniformity of the ink film 343 formed on the substrate 31 can be improved, thereby making this preferable.

Furthermore, solvent alone may be used instead of ink of a lower concentration in the present embodiment corresponding to printing conditions. In addition, although two inkjet heads consisting of the heads 303a and 303b are provided in the present embodiment, three or more heads may also be provided, and each of the heads discharges a solvent or an ink including the solvent and a material component of the organic layer, wherein each of the plurality of heads discharges the solvent or the ink with a concentration of the material component, the concentration being different from concentrations of the material component in inks discharged from other ones of the plurality of the heads

### Third Embodiment

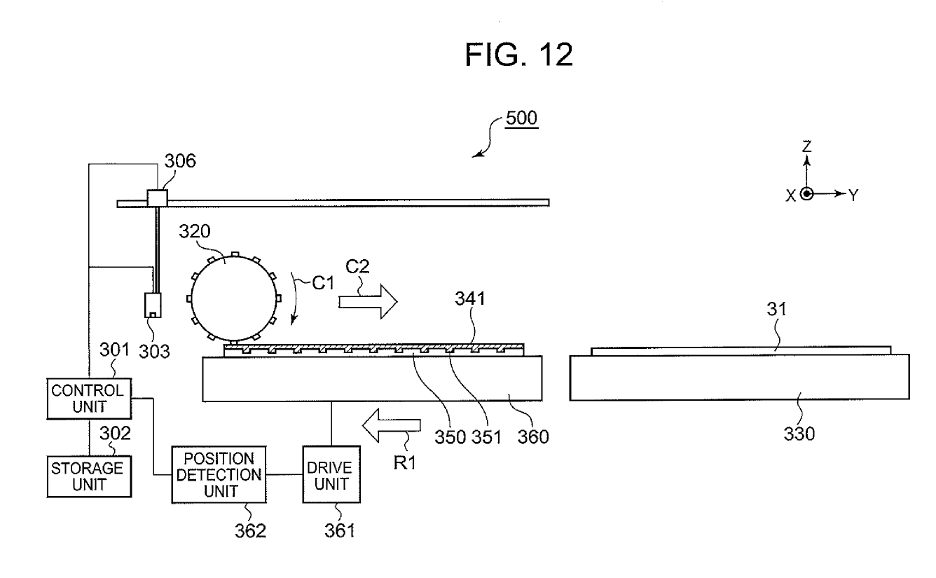

As shown in FIG. 12, a manufacturing device 500 according to a third embodiment differs from the manufacturing device 300 according to the first embodiment in that an anilox plate 350 is used that is obtained by unrolling the anilox roll 310 of the first embodiment into the form of a flat plate. Other components not previously described are explained below.

The anilox plate 350 in the present embodiment is an ink receiving portion formed into the shape of a rectangular plate. Shallow recesses in the form of cells 351, which are equivalent to the cells 311 of the anilox roll 310, are formed in one of the primary surfaces of the anilox roll 350, namely the surface on the side facing the plate cylinder 320. The cells 351 are provided so as to have a prescribed depth, pattern and the like corresponding to printing conditions and the like.

An anilox plate stage 360 is a stand-like member that fixes the anilox plate 350. The anilox plate stage 360 is composed to be able to move at least in the direction of Y axis in the drawing.

A drive unit 361 is a driving device equivalent to the drive unit 312 of the first embodiment, is provided with a linear motor type of drive motor (not shown), and moves the anilox plate stage 360 to a prescribed position based on instructions from the control unit 301.

A position detection unit 362 is a position sensor equivalent to the angle detection unit 313 of the first embodiment, is provided on the anilox plate 350, the anilox plate stage 360 or a drive motor, directly or indirectly detects the position of the anilox plate 350, and transmits a signal indicating that position to the control unit 301.

A head drive unit 306 moves the head 303 in the direction of the Y axis in the drawing and scans in the direction of the X axis in the drawing.

The head drive unit 306 is a driving device equivalent to the head drive unit 305 of the first embodiment, is provided with guide rails extending in the direction of the X axis and the direction of the Y axis (only the guide rail extending in the direction of the Y axis is shown in FIG. 12), and differs from the head drive unit 305 in that it enables the head 303 to scan not only in the direction of the X axis, but also in the direction of the Y axis in the drawing. In addition, the head drive unit 306 causes the ink 340 to be discharged by driving a piezoelectric element incorporated within the head 303 based on instructions from the control unit 301.

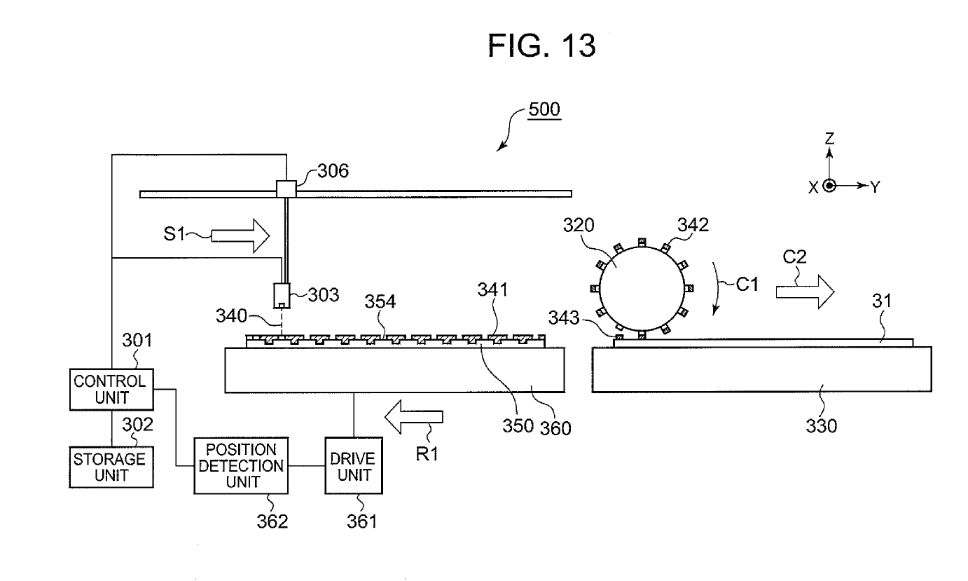

Next, an explanation is provided of operation of the manufacturing device 500 with reference to FIGS. 12 and 13.

First, the head 303 discharges the ink 340 onto the surface of the anilox plate 350. As a result, the ink film 341 is formed over the entire surface of the anilox plate 350. At this time, the plate cylinder 320 is paused at a location that does not interfere with discharge of the ink 340.

Next, as shown in FIG. 12, the plate cylinder 320 moves to a prescribed position over the anilox plate 350. Continuing, the plate cylinder 320 advances in the direction of arrow C2 together with rotating in the direction of arrow C1 while the plate on the plate cylinder 320 contacts the anilox plate 350. In addition, the anilox plate stage 360, on which the anilox plate 350 is placed, moves in the direction of arrow R1 in the opposite direction from that of the arrow C2. As a result, the ink film 341 is transferred to the plate on the plate cylinder 320, and the ink film 342 is formed on the surface of the plate of the plate cylinder 320 as shown in FIG. 3 of the first embodiment. Furthermore, although the anilox plate 350 may stop when transferring ink to the plate of the plate cylinder 320, it preferably advances in a direction (arrow R1) opposite from the direction of advance of the plate cylinder 320 in order to obtain shear force at a suitable pressing force for ink transfer.

Next, the plate cylinder 320 carries out printing onto the substrate 31 as shown in FIG. 13 in the same manner as the first embodiment (see FIG. 4). As a result, the ink film 343 is formed on the substrate 31. In addition, the head 303 replenishes the ink 340 to a portion 354 of the ink film 341 on the anilox plate 350 where the ink 340 has been removed. At this time, the head drive unit 306 moves the head 303 in the direction of arrow S1, and the drive unit 361 moves the anilox plate stage 360 in the direction of arrow R1 that is the opposite direction of arrow S1. If the head 303 replenishes the ink 340 to the portion 354 of the ink film 341 where the ink 340 has been removed during the time the plate cylinder 320 is transferring ink to the substrate 31, ink for the next transfer can be rapidly supplied following completion of transfer by the plate cylinder 320 to the substrate 31 by again contacting the ink film 341 on the anilox plate 350, thereby making it possible to further improve production efficiency.

Maintenance ease is improved by modifying the anilox roll 310 to the flat anilox plate 350 as in the manufacturing device 500. Furthermore, the head drive unit 305 similar to the first embodiment may be used instead of the head drive unit 306. In this case, the driving mechanism of the head 303 can be simplified or omitted (in the case of using a linear head type to be subsequently described), and the ink 340 is coated over the entire anilox plate 350 due to movement by the anilox plate stage 360.

### Fourth Embodiment

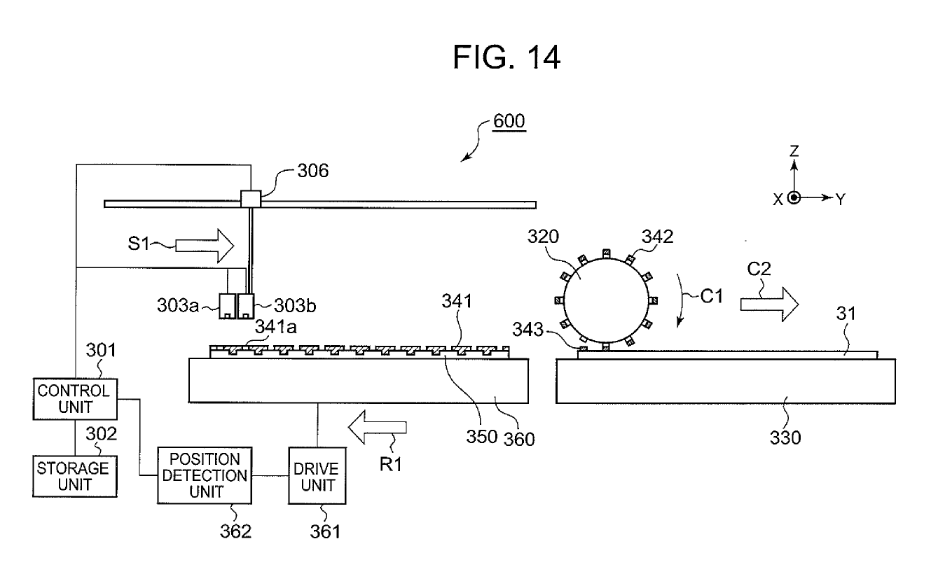

As shown in FIG. 14, a manufacturing device 600 according to a fourth embodiment differs from the manufacturing device 500 according to the third embodiment in that the head 303 is configured by two heads 303a and 303b in the same manner as the second embodiment.

Operation of the manufacturing device 600 is basically the same as that of the manufacturing device 500. In addition, the head 303a discharges the ink 340 of a prescribed concentration, and the head 303b discharges ink of a lower concentration than the ink 340 or a solvent only in the same manner as the second embodiment. The head 303b is able to coat ink or solvent over a portion or the entirety of the surface of the anilox plate 350.

### Fifth Embodiment

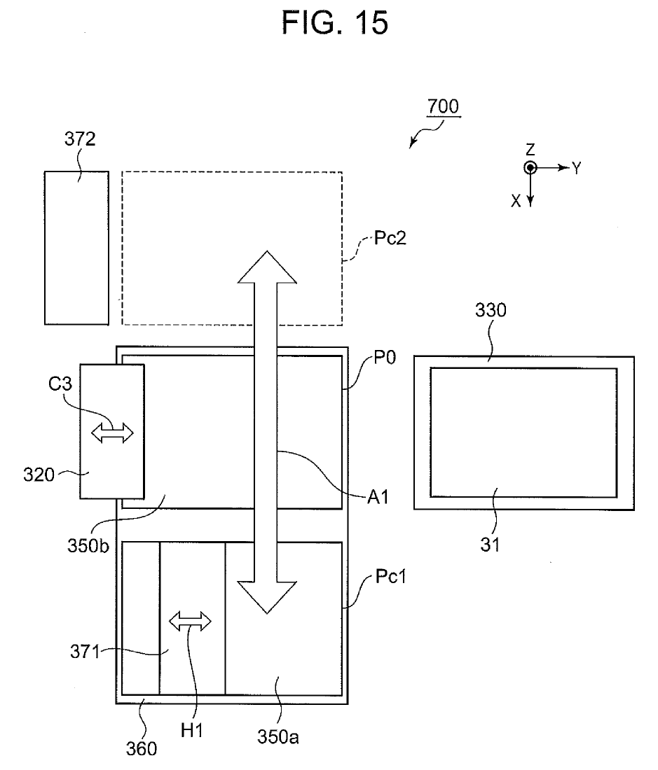

As shown in FIG. 15, a manufacturing device 700 according to a fifth embodiment differs from the manufacturing device 500 of the third embodiment in that it is provided with two anilox plates 350a and 350b, and is provided with two cleaning units 371 and 372. Furthermore, although not shown in the drawing for the purpose of simplification, those constituents other than those explained below are the same as in the third embodiment.

The anilox plates 350a and 350b are each similar to the anilox plate 350 of the third embodiment. In the present embodiment, the anilox plates 350a and 350b are both placed on a common anilox plate stage 360. In addition, in the present embodiment, the drive unit 361 is able to move the anilox plate stage 360 in not only the direction of the Y axis in the drawing, but also in the direction of the X axis (arrow A1) based on instructions from the control unit 301.

In addition, the status of the anilox plates 350a and 350b can be changed by moving the anilox plate stage 360 in the direction of arrow A1. In other words, the status of the anilox plates 350a and 350b can be switched between a state in which the anilox plate 350a is positioned at a cleaning position Pc1 and the anilox plate 350b is positioned at an ink transfer position P0 as indicated by the solid lines in FIG. 15, and a state in which the anilox plate 350a is positioned at the ink transfer position P0 and the anilox pate 350b is positioned at a cleaning position Pc2 indicated with the broken line in FIG. 15. Furthermore, although the anilox plate stage 360 may be separated into a stage dedicated for use with the anilox plate 350a and a stage dedicated for use with the anilox plate 350b, if the two anilox plates 350a and 350b are placed on a single anilox plate stage 360 as in the present embodiment, there is the advantage of eliminating any changes in the mutual positional relationship between the two anilox plates 350a and 350b.

The cleaning unit 371 is a cleaning device that scans, cleans, wipes, carries out plasma cleaning at atmospheric pressure and radiates ultraviolet (UV) light onto the anilox plate 350a when the anilox plate 350a is at the cleaning position Pc1. As a result, the cleaning unit 371 is able to carry out maintenance on the anilox plate 350a.

The cleaning unit 372 is a cleaning device that scans, cleans, wipes, carries out plasma cleaning at atmospheric pressure and radiates ultraviolet (UV) light onto the anilox plate 350b when the anilox plate 350b is at the cleaning position Pc2. As a result, the cleaning unit 372 is able to carry out maintenance on the anilox plate 350b. Furthermore, the cleaning units 371 and 372 both operate in accordance with instructions from the control unit 301, and are able to move in the direction of the Y axis (arrow H1) in the drawing.

Next, an explanation is provided of the operation of the manufacturing device 700. Coating of the ink 340 onto the anilox plate 350a and the anilox plate 350b and transfer of the ink 340 to the plate on the plate cylinder 320 are carried out at the transfer position P0 of FIG. 15. Subsequent operation through printing onto the substrate 31 is the same as that of the third embodiment. The plate cylinder 320 repeats the above-mentioned process by reciprocating in the direction of the Y axis (arrow C3) in the drawing.

In addition, the two anilox plates 350a and 350b are used alternately in the present embodiment. For example, after having carried out printing as described above by using the anilox plate 350a, the drive unit 361 moves the anilox plate stage 360 so that the anilox plate 350a is at the cleaning position Pc1 when the number of printing operations reaches a prescribed number of operations.

Continuing, the cleaning unit 371 cleans the surface of the anilox plate 350a according to the method described above.

During maintenance on the anilox plate 350a at the cleaning position Pc1, the anilox plate 350b, which currently can be used for printing, is located at the ink transfer position P0. Thus, printing can be continued using the anilox plate 350b concurrent to maintenance on the anilox plate 350a. When a prescribed number of operations of printing have been completed using the anilox plate 350b, the drive unit 361 moves the anilox plate stage 360 so that the anilox plate 350b is at the cleaning position Pc2. Use of the anilox plates 350a and 350b for printing and maintenance thereof are subsequently similarly carried out in an alternating manner.

As has been explained above, operation rate as a manufacturing device can be improved by providing a plurality of ink receiving portions (anilox plates 350a and 350b). Furthermore, although the case of using anilox plates is described in the present embodiment, two anilox rolls may be procured as in the first embodiment, and their use for printing and maintenance thereon may be alternately carried out. In addition, although two cleaning units 371 and 372 are used in the present embodiment for the sake of convenience in the drawing, the cleaning units 371 and 372 may also be integrally configured into a single unit.

### Sixth Embodiment

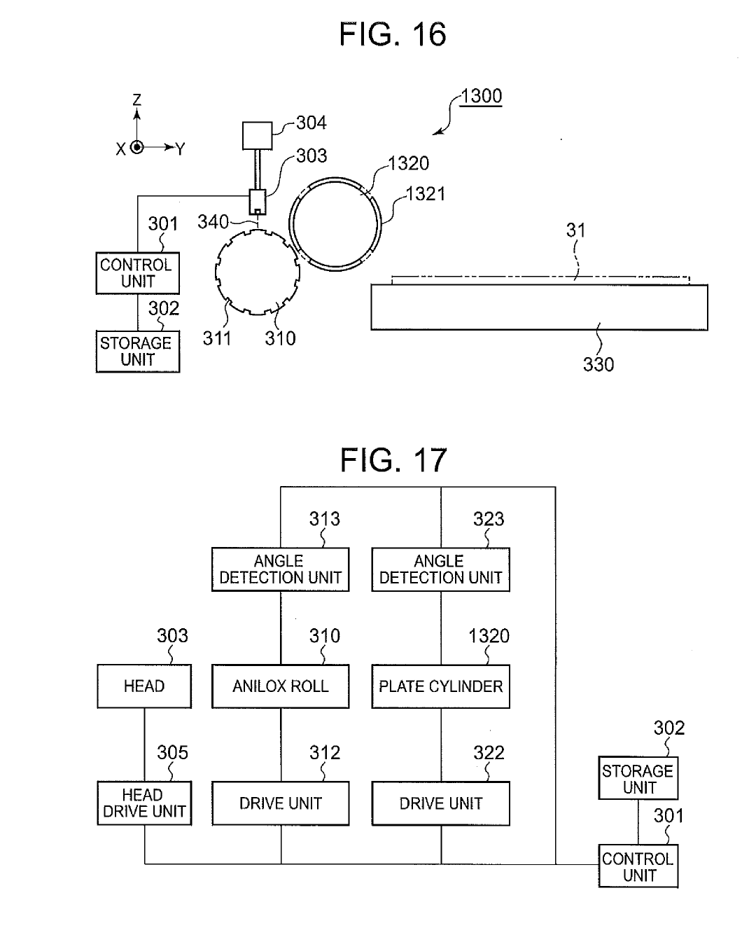

As shown in FIG. 16, a manufacturing device 1300 according to a sixth embodiment is provided with the control unit 301, the storage unit 302, the head 303, the ink container 304 containing the ink 340, the anilox roll 310, a plate cylinder 1320 and the printing stage 330.

The control unit 301 is provided with a central processing unit (CPU) and the like, and controls all functions of the manufacturing device 1300, including discharge of ink from the head 303 to be subsequently described, and driving of the anilox roll 310 and the plate cylinder 1320.

The storage unit 302 is a storage device comprising a read only memory (ROM) or random access memory (RAM) and the like. The storage unit 302 houses, for example, a program executed by the control unit 301, and data relating to patterns printed by the plate cylinder 1320. In addition, the storage unit 302 also functions as, for example, workspace memory when the control unit 301 executes a program.

The head 303 discharges the ink 340 from the head 303 towards the anilox roll 310 based on instructions from the control unit 301. In the present embodiment, the head 303 is provided with a piezoelectric element (not shown), and discharges the ink 340 by a so-called inkjet method. In addition, the head 303 is configured to be able to discharge the ink 340 while scanning in the direction of the X axis in the drawing according to the length of the anilox roll 310. The ink container 304 contains the ink 340 therein, and supplies the ink 340 to the head 303. The ink 340 in the present embodiment is, for example, a solution of a prescribed polymer material that serves as a material of the light emitting layer of an organic EL element.

The anilox roll 310 is rotatably supported about a rotating shaft (not shown) parallel to the X axis in the drawing, and has a prescribed length in the direction of the X axis. A large number of shallow recesses, namely the cells 311, are formed in the outer peripheral surface, namely the surface that receives the ink 340, of the anilox roll 310. Although the cells 311 are depicted in a simplified form in FIG. 16, the cells 311 are provided so as to have a prescribed depth, pattern and the like corresponding to printing conditions. Furthermore, if the head 303 extends in the direction of the X axis corresponding to the length in the direction of the X axis of the anilox roll 310, and a plurality of discharge ports that arbitrarily discharge the ink 340 are arranged along the X axis, the ink 340 can be discharged into the arbitrary cells 311 of the anilox roll 310 without having the head 303 scan in the direction of the X axis.

The plate cylinder 1320 is rotatably supported about a rotating shaft (not shown) parallel to the X axis in the drawing, and has a prescribed length in the direction of the X axis. As will be subsequently described, in addition to rotating about the rotating shaft as previously described (not shown), the plate cylinder 1320 is configured to also be able to move parallel to a printed surface of the substrate 31 (move in the direction of the Y axis in the drawing) placed on the printing stage 330, and move in a direction perpendicular to the printed surface of the substrate 31 (namely, a direction normal to the printed surface, or in other words, in the direction of the Z axis in the drawing). One or a plurality of protrusions 1321 of a flexographic plate are formed on the outer peripheral surface of the plate cylinder 1320. The plate protrusions 1321 are formed to have a prescribed pattern corresponding to a printed light emitting layer and the like, receive the ink 340 from the anilox roll 310, and transfer that ink 340 to the substrate 31 targeted for printing. A portion of the flexographic plate on the plate cylinder 1320 (that includes the protrusions 1321) is formed from a material suitable for flexographic printing such as plastic or rubber. Furthermore, the substrate 31 is fixed on the printing stage 330 in the present embodiment.

The printing stage 330 is a stage for placing the substrate 31 targeted for printing by the manufacturing device 1300 parallel to the XY plane in the drawing. Furthermore, a detailed explanation of the configuration of the printing stage 330, such as the mechanism used to fix the substrate 31, is omitted in the present specification.

FIG. 17 is a block diagram showing a detailed configuration relating to the control unit 301 of the manufacturing device 1300. As shown in FIG. 17, in addition to having the configuration shown in FIG. 16, the manufacturing device 1300 is provided with the head drive unit 305, the drive unit 312, the angle detection unit 313, the drive unit 322 and the angle detection unit 323.

The head drive unit 305 discharges the ink 340 by driving a piezoelectric element incorporated within the head 303 based on instructions from the control unit 301. In addition, the head drive unit 305 is provided with a mechanism such as a drive motor (not shown) and rail, and causes the head 303 to scan in the direction of the X axis in the drawing.

The drive unit 312 is provided with a direct drive type of drive motor (not shown), and causes the ink 340 discharged from the head 303 to reach a prescribed position on the anilox roll 310 by rotating the anilox roll 310 based on instructions from the control unit 301.

The angle detection unit 313 is an angle sensor provided on the rotating shaft of the anilox roll 310 or a drive motor. The angle detection unit 313 directly or indirectly detects the position of the anilox roll 310, and transmits a signal indicating that position to the control unit 301.

The drive unit 322 is provided with a direct drive type of drive motor (not shown), and causes, by rotating the plate cylinder 1320, the ink 340 discharged onto the anilox roll 310 to be transferred to a prescribed position on the plate cylinder 1320, or causes the plate cylinder 1320 to move in the direction of the Y axis and Z axis in the drawing as will be subsequently described, based on instructions from the control unit 301.

The angle detection unit 323 is an angle sensor provided on the rotating shaft of the plate cylinder 1320 or a drive motor, directly or indirectly detects the position of the plate cylinder 1320, and transmits a signal indicating that position to the control unit 301.

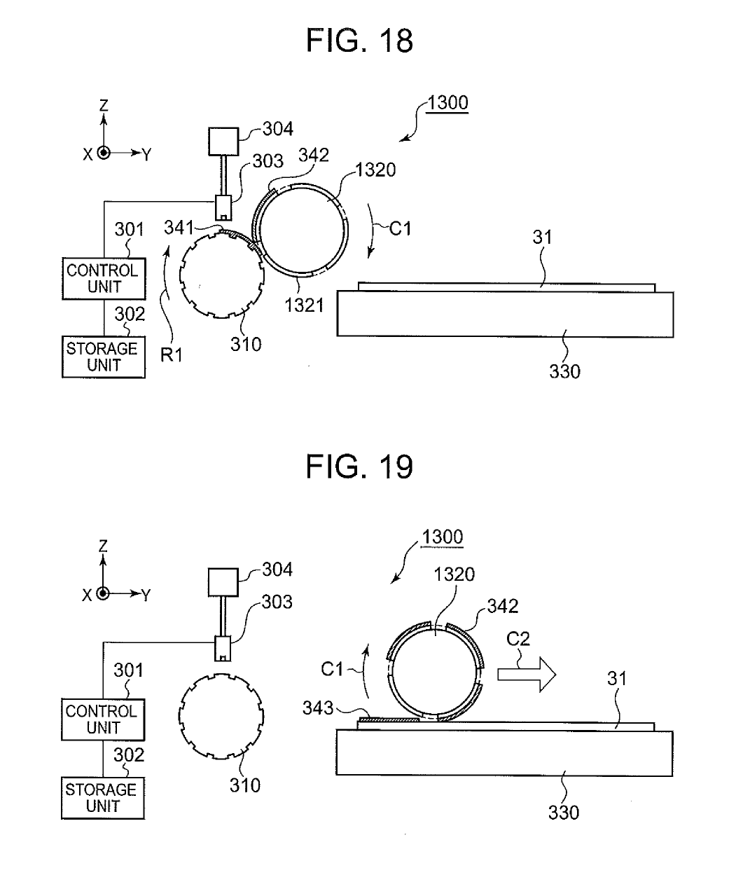

Next, an explanation is provided of operation of the manufacturing device 1300 with reference to FIGS. 18 and 19. Furthermore, unless specifically indicated otherwise, operation of the manufacturing device 1300 as described below is carried out based on instructions from the control unit 301. In addition, in the following explanation, a surface of the anilox roll 310 refers to the outer peripheral surface of the anilox roll 310 that includes the range of the cells 311.

First, the control unit 301 calculates the position of the anilox roll 310 based on a signal from the angle detection unit 313 corresponding to the anilox roll 310. Continuing, the control unit 301 calculates an ink coating region on the surface of the anilox roll 310 from a printing pattern stored in the storage unit 302. In the present embodiment, the ink coating region is the surface of the plate protrusions 1321 provided on the plate cylinder 1320.

Next, the head 303 discharges the ink 340 onto the calculated ink coating region, and forms the ink film 341 filled with the ink 340 on the surface of the anilox roll 310. At this time, the anilox roll 310 rotates in the direction of arrow R1. In addition, the head 303 covers the range of the length of the anilox roll 310 by scanning in the direction of the X axis in the drawing. In other words, the head 303 is able to discharge the ink 340 over the entire range of the length of the anilox roll 310.

The ink 340 of the ink film 341 coated onto the anilox roll 310 serving as an intermediate transfer member is transferred onto the protrusions 1321 of the plate of the plate cylinder 1320 due to contact between the anilox roll 310 and the plate on the plate cylinder 1320. The plate cylinder 1320 rotates in the direction of arrow C1. In the example of FIG. 18, the ink 340 of the ink film 342 on a certain plate protrusion 1321 is transferred from the anilox roll 310, after which the ink film 341 shown is transferred from the anilox roll 310 to the adjacent plate protrusion 1321 thereof. Nearly all of the ink film 341 is removed from the anilox roll 310 by transfer from the anilox roll 310 to the plate of the plate cylinder 1320 in this manner.

When formation of the ink film 342 on the plate provided on the plate cylinder 1320 is completed as a result of ink transfer, the drive unit 322 moves the plate cylinder 1320 to a prescribed position over the substrate 31. Subsequently, as shown in FIG. 19, with the plate cylinder 1320 being rotated in the direction of arrow C1 while contacting the substrate 31, the ink film 342 is transferred to the substrate 31 while advancing in the direction of arrow C2. As a result, the ink film 343 is formed on the substrate 31. Furthermore, nearly all of the ink film 341 is removed from the surface of the anilox roll 310 following transfer to the plate on the plate cylinder 1320 as previously described.

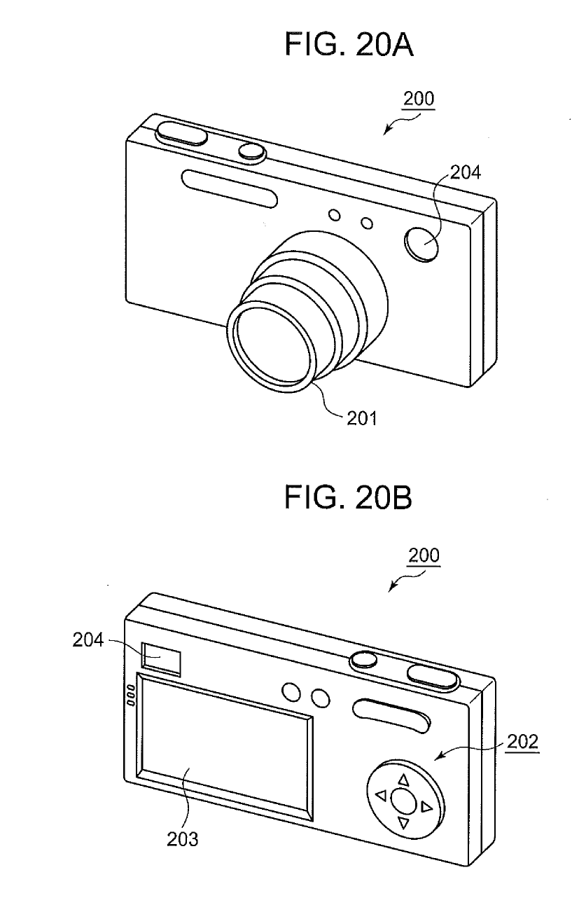

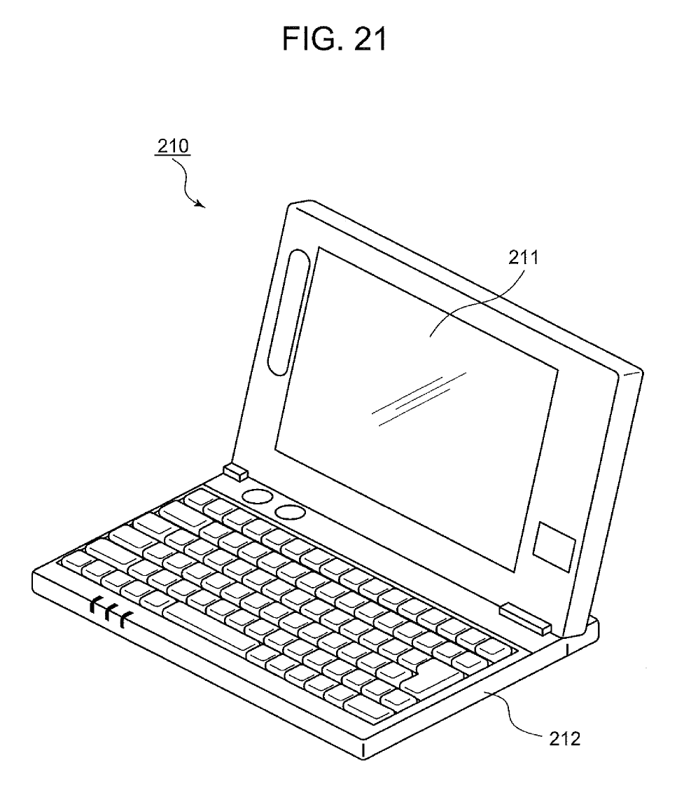

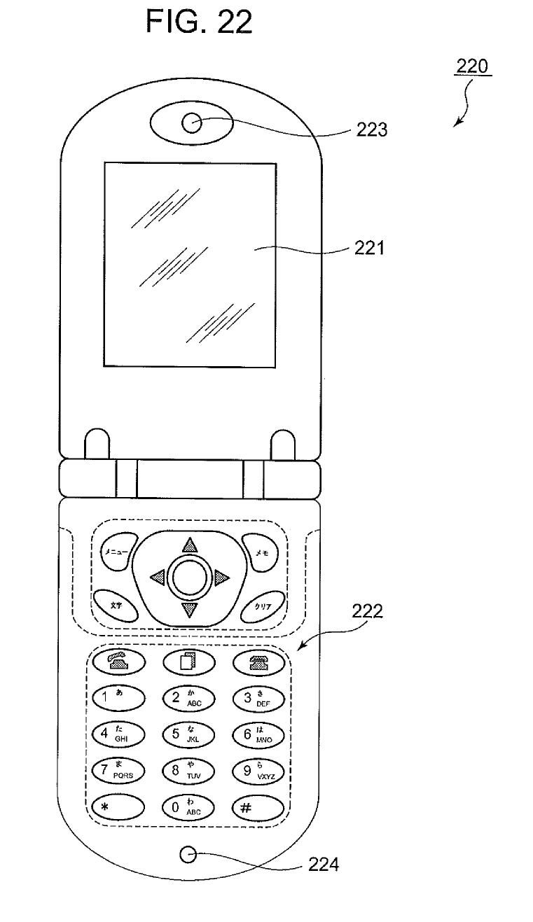

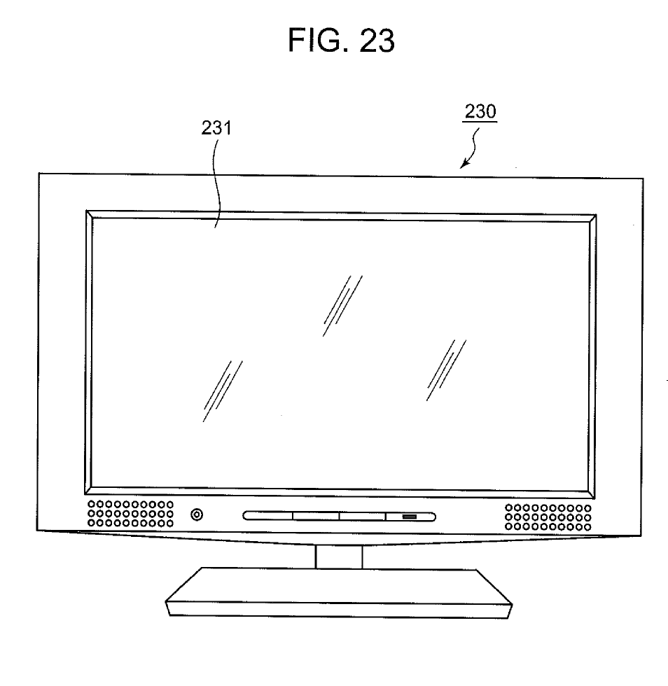

Furthermore, although an example of manufacturing the light emitting device 10 using the manufacturing device 300 was indicated in the first embodiment, the light emitting device 10 can be manufactured using any of the devices according to the second to sixth embodiments, namely any of the manufacturing devices 400, 500, 600, 700 and 1300. In addition, the light emitting device 10 is used as a display unit (display) of electronic equipment such as a digital camera, personal computer or cell phone and the like. For example, a shown in, for example, FIGS. 20A and 20B, a digital camera 200 is provided with a lens unit 201, an operating unit 202, a display unit 203 and a finder 204, and the light emitting device 10 is used in the display unit 203 of this digital camera 200. In addition, although a personal computer 210 is provided with a display unit 211 and an operating unit 212 as shown in FIG. 21, the light emitting device 10 is used in the display unit 211 of this personal computer 210. In addition, although a cell phone 220 is provided with a display unit 221, an operating unit 222, an earpiece unit 223 and a mouthpiece unit 224 as shown in FIG. 22, the light emitting device 10 is used in the display unit 221 of the cell phone 220. In addition, although a large-screen television 230 is provided with a display unit 231 as shown in FIG. 23, the light emitting device 10 is used in the display unit 231 of this large-screen television 230.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

For example, although the light emitting device 10 was explained in the above-mentioned embodiments using as an example that which carries out color display and has a configuration provided with three colors of light emitting elements, applications of the present invention are not limited thereto. The present invention can also be applied to an apparatus and method for manufacturing a light emitting device that emits 2 or 4 or more colors of light. In addition, although the light emitting device 10 is provided with only a light emitting element of one color in the case of carrying out monochromatic display, the present invention can also be applied to an apparatus and method for manufacturing such a light emitting device.

In addition, although an example of a configuration is described in the above-mentioned embodiments in which a light emitting function layer is provided with the hole injection layer 43, the inner layer 44 and the light emitting layer 45 (R, G, B), applications of the present invention are not limited thereto. For example, the present invention can also be applied to a light emitting device that comprises a light emitting function layer from the hole injection layer 43 and the light emitting layer 45, or a light emitting device that uses only the light emitting layer 45 as a light emitting function layer.

In addition, although an example of a configuration is described in the above-mentioned embodiments in which the pixel circuit DS is provided with two transistors, it may also be provided with three or more transistors.

In addition, although explanations of the above-mentioned embodiments focused on a bottom emission type of organic EL element, applications of the present invention are not limited to a bottom emission type of organic EL element. The present invention can also be applied to an apparatus and method for manufacturing an organic EL element of the top emission type that emits light generated by the organic EL element OEL to the outside through a counter electrode.

In addition, although an example of a configuration is described in the above-mentioned embodiments in which a light emitting device is used as a display device, the present invention can also be applied to an apparatus and method for manufacturing a light emitting device that is used as an exposure device of a printer head and the like that radiates light onto a photosensitive drum of a printer.

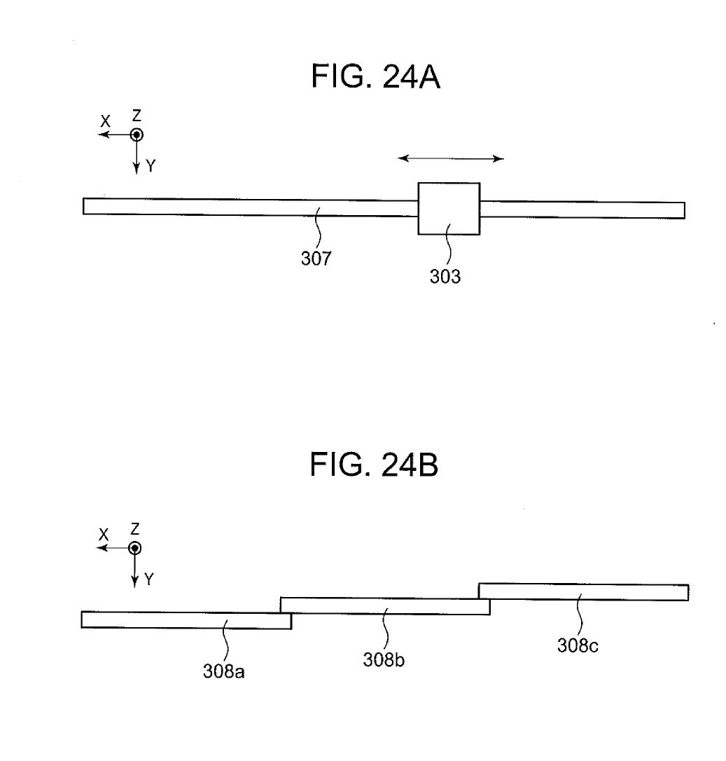

In addition, the head 303 is explained in the above-mentioned embodiments as that of a so-called serial head type that scans in the direction of the X axis in the drawings. Although the head 303 scans along a guide rail 307 shown in FIG. 24A, for example, in the case of a serial head type, it may also be in the form of a so-called linear head type that is provided with a plurality of discharge ports (nozzles), for example. In this case, although there may be only one head, three heads consisting of heads 308a, 308b and 308c as shown in FIG. 24B, for example, may be arranged in a staggered manner as viewed from the direction of the Z axis. As a result, a configuration for scanning with the head 303 of the head drive unit 305 or the head drive unit 306 can be omitted or simplified. In addition, the use of a linear head type is preferable by enabling the printing process to be shortened since printing can be carried out all at once over a wide range. Furthermore, in this case, by presetting the operating waveform for the piezoelectric element possessed by each nozzle based on the discharge volume of each nozzle and storing those settings in the storage unit 302, the discharge volume of each nozzle can be maintained constant, thereby making this preferable.

In addition, configurations of each of the embodiments and variations described above can naturally be suitably combined.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. An apparatus for manufacturing a light emitting device provided with a plurality of light emitting elements arranged on a substrate, comprising:
a rotating plate cylinder provided with a flexographic plate printing ink that forms an organic layer of the light emitting elements on the substrate;
an intermediate transfer member that contacts the flexographic plate to transfer the ink,
a head unit that supplies the ink to the intermediate transfer member;
a storage unit that stores as an ink replenishment pattern a region in which the ink is removed from the intermediate transfer member by the transfer of the ink from the intermediate transfer member to the flexographic plate; and
a control unit that supplies the ink from the head unit to the region of the ink replenishment pattern on a surface of the intermediate transfer member.

2. The apparatus for manufacturing a light emitting device according to claim 1, further comprising a head drive unit that moves the head unit to a position corresponding to the ink replenishment pattern.

3. The apparatus for manufacturing a light emitting device according to claim 1, wherein
the head unit discharges the ink onto the intermediate transfer member, using an inkjet method.

4. The apparatus for manufacturing a light emitting device according to claim 1, wherein
the head unit is provided with a plurality of nozzles, the positions of which are mutually fixed and which discharge the ink respectively,
the plurality of nozzles is respectively provided with a piezoelectric element that discharges the ink, as droplets, using an inkjet method,
the storage unit stores an operating waveform of each of the piezoelectric elements, and
the control unit performs control such that the discharge volume of the ink from each piezoelectric element is uniform based on the operating waveforms.

5. The apparatus for manufacturing a light emitting device according to claim 1, wherein
the light emitting elements are organic electroluminescence elements, and
the ink contains a material that serves as an organic layer of the organic electroluminescence elements.

6. The apparatus for manufacturing a light emitting device according to claim 1, wherein the intermediate transfer member is a rotating anilox roll.

7. The apparatus for manufacturing a light emitting device according to claim 1, wherein the intermediate transfer member is a plate-like anilox plate.

8. The apparatus for manufacturing a light emitting device according to claim 7, wherein the anilox plate and the plate cylinder move in mutually opposite directions during the transfer.

9. The apparatus for manufacturing a light emitting device according to claim 1, wherein the head unit is provided with a plurality of heads, each of which discharges a solvent or an ink including the solvent and a material component of the organic layer, wherein each of the plurality of heads discharges the solvent or the ink with a concentration of the material component, the concentration being different from concentrations of the material component in inks discharged from other ones of the plurality of the heads

10. An apparatus for manufacturing a light emitting device provided with a plurality of light emitting elements arranged on a substrate, comprising:
a rotating plate cylinder provided with a flexographic plate printing ink that forms an organic layer of the light emitting elements on the substrate;
first and second intermediate transfer members that contact the flexographic plate to transfer the ink;
a head unit that supplies the ink to the first and second intermediate transfer members,
a storage unit that stores as ink replenishment patterns regions in which the ink is removed from the intermediate transfer members by the transfer of the ink from the intermediate transfer members to the flexographic plate;
a control unit that supplies the ink from the head unit to the regions of the ink replenishment patterns on the surfaces of the intermediate transfer members;
an intermediate transfer medium movement device that alternately moves the first and second intermediate transfer members so that one of the intermediate transfer members is at a position where one of the intermediate transfer members is related to the transfer of the ink from the intermediate transfer members to the flexographic plate and the other one of the intermediate transfer members is at a position where the other one of the intermediate transfer members is related to maintenance; and
a cleaning device that cleans the other one of the intermediate transfer members that is at the position where the other one of the intermediate transfer members is related to the maintenance.

11. An apparatus for manufacturing a light emitting device provided with a plurality of light emitting elements arranged on a substrate, comprising:
a rotating plate cylinder provided with a flexographic plate for printing ink that forms an organic layer of the light emitting elements on the substrate;
an intermediate transfer member that contacts the flexographic plate to transfer the ink;
a head unit that supplies the ink to the intermediate transfer member;
a storage unit that stores an ink supply pattern on a surface of the intermediate transfer member as a printing pattern to be printed on the substrate; and
a control unit that supplies the ink from the head unit to a region of the ink supply pattern of the intermediate transfer member.

12. A manufacturing method of a light emitting device provided with light emitting elements, the method comprising:
supplying an ink containing a material of an organic layer of the light emitting elements to an intermediate transfer member, and forming an ink film on the surface of the intermediate transfer member;
transferring the ink film from the intermediate transfer member to a flexographic plate; and
printing on a substrate the ink film transferred to the flexographic plate, wherein an inkjet head selectively replenishes the ink to a region to which the ink has been moved from the intermediate transfer member by the transfer, and reforms the ink film on a surface of the intermediate transfer member.

13. The manufacturing method of a light emitting device according to claim 12, wherein, after the reformation of the ink film, a solvent or an ink having a lower concentration of a material of the organic layer than a concentration of a material of the organic layer in the ink having remained after the intermediate transfer is supplied to a part of or the entire surface of the intermediate transfer member.

14. The manufacturing method of a light emitting device according to claim 12, wherein a region where the ink of the intermediate transfer member is moved to the flexographic plate is stored as an ink replenishment pattern before the ink of the intermediate transfer member is moved to the flexographic plate, and
the inkjet head unit is moved to a position corresponding to the ink replenishment pattern.

15. The manufacturing method of a light emitting device according to claim 12, wherein the intermediate transfer member is a rotating anilox roll.

16. The manufacturing method of a light emitting device according to claim 12, wherein a position of the intermediate transfer member is detected by detecting an angle of the intermediate transfer member.

17. The manufacturing method of a light emitting device according to claim 12, wherein the intermediate transfer member is a plate-like anilox plate.

18. The manufacturing method of a light emitting device according to claim 16, wherein the anilox plate and the plate cylinder move in mutually opposite directions during the transfer.

19. A manufacturing method of a light emitting device provided with light emitting elements, the method comprising:
selectively supplying an ink containing a material of an organic layer of the light emitting elements to a region, on a surface of an intermediate transfer member, that is to contact a flexographic plate of a plate cylinder in use of an inkjet method;
transferring the ink from the intermediate transfer member to the flexographic plate of the plate cylinder; and
printing on a substrate the ink from the plate cylinder.
